(19) United States
(12) Patent Application Publication
(10) Pub. No.: US 2003/0177367 A1
(43) Pub. Date: Sep. 18, 2003

(54) Controlling access to a disk drive in a computer system running multiple operating systems

(75) Inventors: Brian James King, Rochester, MN (US); Timothy Jerry Schimke, Sewartville, MN (US)

Correspondence Address: IBM Corporation, Intellectual Property Law Dept.917, 3605 Hwy. 52 North, Rochester, MN, 55901, US

(73) Assignee: International Business Machines Corporation, New York, NY

(21) Appl. No.: 10/097,425

(22) Filed: Mar. 14, 2002

(51) Int. Cl. H04K 1/00; H04L 9/00

(52) U.S. Cl. 713/185; 713/182

(57) ABSTRACT

In a first aspect and in a computer system that runs more than one operating system, a procedure for controlling access to a data storage device is provided. The data storage device stores a token which identifies the operating system to which the data storage device is assigned. An operating system seeking to access the data storage device is identified by a token, and if that token does not match the token stored in the data storage device, access to the data storage device is prevented.

### FIELD OF THE INVENTION

The present invention relates to computer systems, and more particularly to computer systems in which plural operating systems are employed.

### BACKGROUND OF THE INVENTION

FIG. 1 is a block diagram which illustrates a conventional computer system in which the present invention may be applied. Reference numeral 10 generally indicates the computer system. The computer system 10 includes a processing block 12, which may include one or more processors (not separately shown). Associated with the processing block 12 is operating system software including plural operating systems 14-1, 14-2, etc. As is well known to those who are skilled in the art, the purpose of an operating system is to control input/output and other basic operations of the processing block 12. Various application software programs may also be associated with the processing block 12, though not separately shown.

The processing block 12 is connected via a peripheral bus 16 to a storage adapter 18 and a network adapter 20. The peripheral bus 16 may be provided, for example, in accordance with the well-known PCI standard. Associated with the processing block 12 are first device drivers 22-1 and 22-2 which are respectively associated with a first operating system 14-1 and a second operating system 14-2 and are provided to manage the storage adapter 18. For each additional operating system (not separately shown) resident in the processing block 12 a respective first device driver (not separately shown) is also provided to manage the storage adapter 18. Also associated with the processing block 12 are second device drivers 24-1, 24-2, provided to manage the network adapter 20 and respectively associated with the first operating system 14-1 and the second operating system 14-2. For each additional operating system resident in the processing block a respective second device driver (not separately shown) is provided to manage the network adapter 20.

Data storage devices (e.g., disk drives) 26 are connected to the storage adapter 18 via a device bus 28. The device bus 28 may, for example, operate in accordance with the well-known SCSI standard.

In accordance with conventional practice, the storage adapter 18 translates higher level commands from the processing block 12 into lower level commands that are understood by the storage devices 26. The storage adapter 18 may also perform error recovery processing and data buffering. The storage adapter 18 may also include cache memory (not shown) in addition to cache memory (not shown) that is on board the processing block 12. Moreover, the storage adapter 18 may manage a cross drive redundancy scheme such as the conventional RAID (“redundant array of independent disks”) scheme.

The network adapter 20 may be arranged to operate in accordance with a known networking standard, such as Ethernet.

Another conventional computer system, in which the present invention may be applied, is illustrated in FIG. 1A. the computer system 10′ of FIG. 1A differs from the computer system 10 of FIG. 1, in that the stand-alone storage adapter 18 and associated storage devices 26 shown in FIG. 1 are replaced by a storage subsystem 27 connected to the peripheral bus 16 via an interface adapter such as a host bus adapter (HBA) 27a (e.g., to allow the storage subsystem 27 to be used over greater distances). The peripheral bus 16 and the HBA 27a may be connected, for example, via a storage network bus 27b such as a Fiber Channel or the like. As is familiar to those who are skilled in the art, a storage subsystem is a conventional arrangement that encompasses plural storage adapters each having storage devices (e.g., disk drives) associated therewith. A typical storage subsystem is illustrated in block diagram form in FIG. 1B. Referring to FIG. 1B, the storage subsystem 27 includes a processing complex 29, to which plural storage adapters 18 are connected. A respective plurality of storage devices 26 are connected to each storage adapter 18. Also connected to the processing complex 29 are port adapters 31, which allow the storage subsystem 27 to be interfaced to a plurality of host systems simultaneously (although the storage subsystem is shown attached to only one host in FIG. 1A). The processing complex 29, as is well known, provides translation, mapping and processing (e.g., caching) functions. The storage subsystem 27 shown in FIG. 1A may, for example, be the Enterprise Storage Server available from International Business Machines Corporation, the assignee hereof.

As illustrated by the computer systems of FIGS. 1 and 1A, there is a trend toward running plural operating systems concurrently in computer systems. In such cases, individual data storage devices 26 are assigned to each of the operating systems. Alternatively one or more of the data storage devices 26 may be partitioned among two or more of the operating systems.

According to known practices, each operating system writes configuration data stored by the operating system in the storage devices that are assigned to it. Typically, the configuration data stored by the operating system in the storage device includes an identifier which is used to uniquely identify the storage device. The identifier can be used by the operating system to keep track of storage devices that are assigned to it, and to distinguish such storage devices from each other.

Usually the operating system configuration data is written at or near the beginning of the address space of the storage device. However, there is no standard location in which configuration data is written, and the locations for writing the configuration data accordingly vary from operating system to operating system.

One concern that arises with computer systems running multiple operating systems is corruption of data when a storage device is being transferred from one operating system to another. When the transfer is intentional and planned, data corruption can generally be avoided by suitably disposing of data that belongs to the releasing operating system. However, in the case of an operator error, in which a storage device is transferred briefly from one operating system to another and then back to the first operating system, the present inventors have recognized that writing of the configuration data by the second operating system may corrupt user data that was stored in the storage device by the first operating system.

### SUMMARY OF THE INVENTION

According to an aspect of the invention, a method of operating a data storage device includes associating the data storage device with a first operating system, and storing in the data storage device data that identifies the first operating system.

In at least one embodiment, the storing of the identifying data may be performed in response to associating the data storage device with the first operating system. The method may further include preventing a second operating system from accessing the data storage device. For example, the preventing of the second operating system from accessing the data storage device may include referring to the stored data that identifies the first operating system.

According to a second aspect of the invention, a method of operating a data storage device is provided. The method according to this aspect of the invention includes receiving an access command that requests access to the data storage device, receiving a first token that identifies an operating system that issued the access command, retrieving from the data storage device a second token that identifies an operating system with which the data storage device is associated, comparing the first and second tokens, allowing access to the data storage device if the first and second tokens match, and preventing access to the data storage device if the first and second tokens do not match. The access command may be, for example, a write command.

By storing in the data storage device data which identifies an operating system to which the data storage device has been assigned, and using the stored OS (operating system) identifying data to control access to the data storage device, corruption of user data by writing of configuration data of another operating system can be prevented. The invention can be implemented at the level of a storage adapter, at the individual storage device level, or at the level of a storage subsystem that includes multiple storage adapters each having multiple storage devices connected thereto. The invention also can be implemented at the device driver level (e.g., by employing a unique device driver for each operating system). The present invention may be implemented without modifying the operating systems being employed.

The above methods may be implemented in, for example, a computer system that includes a processing block including one or more processors, a storage adapter connected to the processing block, and a storage device connected to the storage adapter. The storage adapter and the storage device may be part of a storage subsystem that is connected to the processing block. Numerous other aspects are provided, as are computer program products. Each inventive computer program product may be carried by a medium readable by a computer (e.g., a carrier wave signal, a floppy disk, a hard drive, a random access memory, etc.).

Other objects, features and advantages of the present invention will become more fully apparent from the following detailed description of exemplary embodiments, the appended claims and the accompanying drawings.

### BRIEF DESCRIPTION OF THE DRAWINGS

FIG. 1 is a block diagram representation of a conventional computer system in which the present invention may be applied;

FIG. 1A is a block diagram representation of another conventional computer system in which the present invention may be applied;

FIG. 1B is a block diagram representation of a storage subsystem that is included in the computer system of FIG. 1A; and

FIG. 2 is a flow chart that illustrates an inventive method of controlling access to a disk drive.

### DETAILED DESCRIPTION

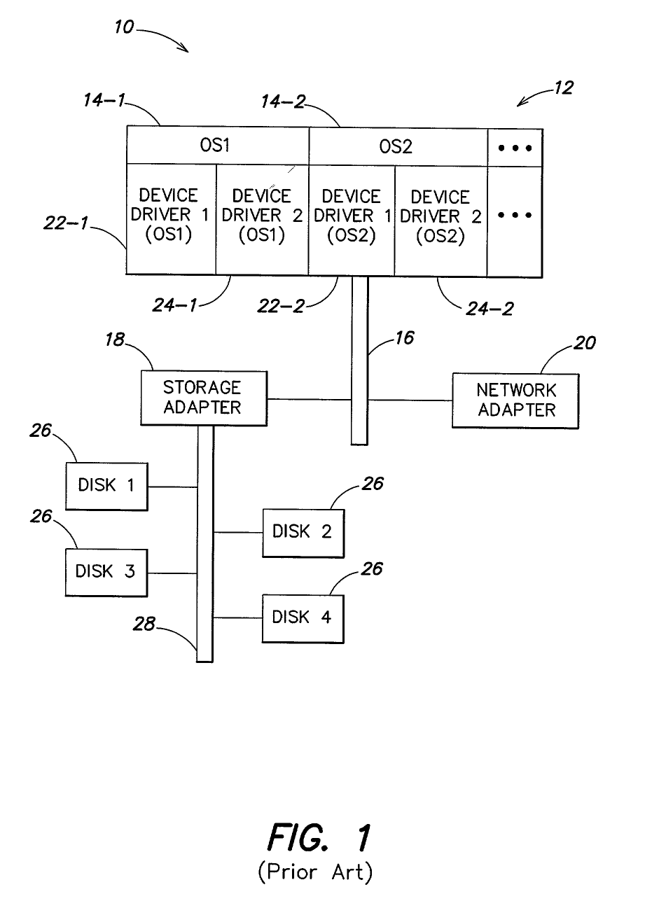

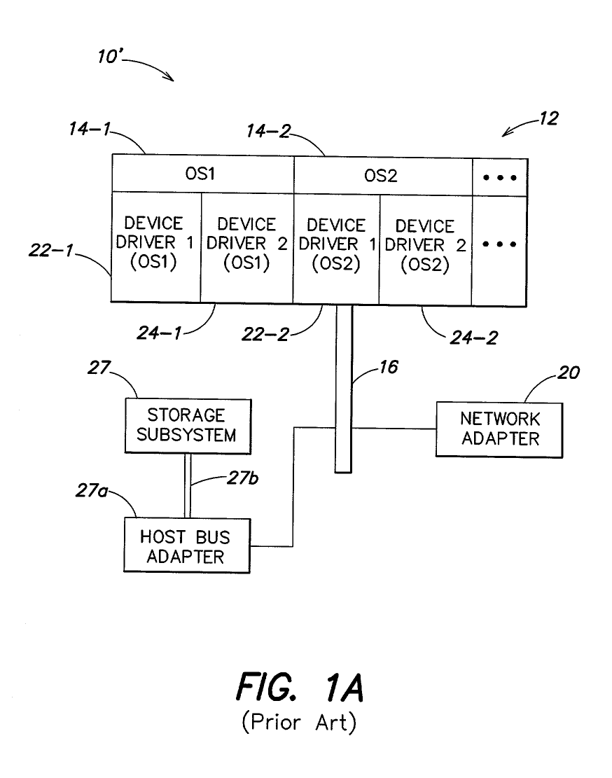

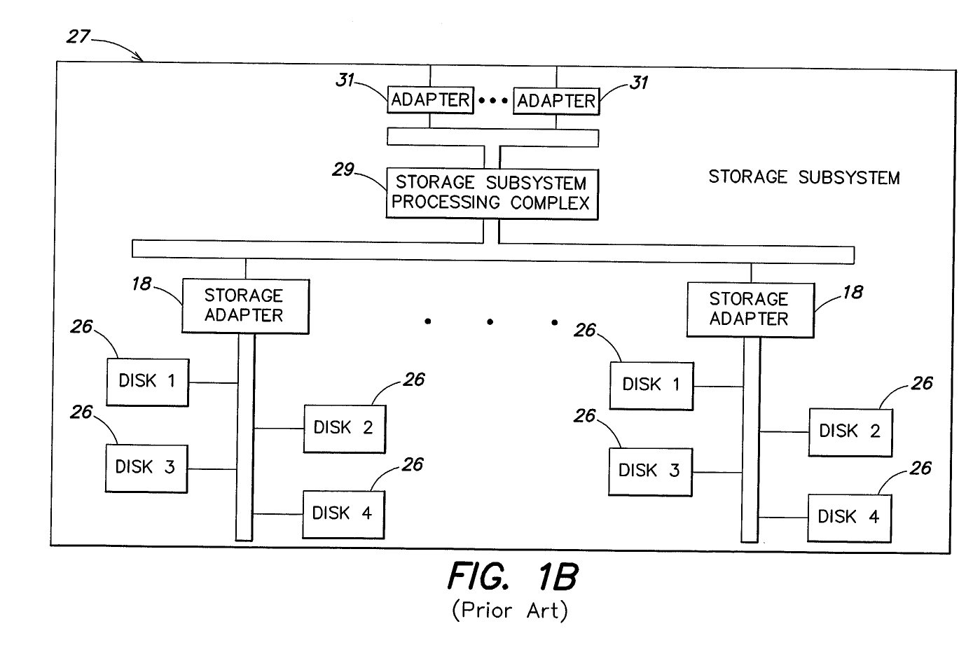

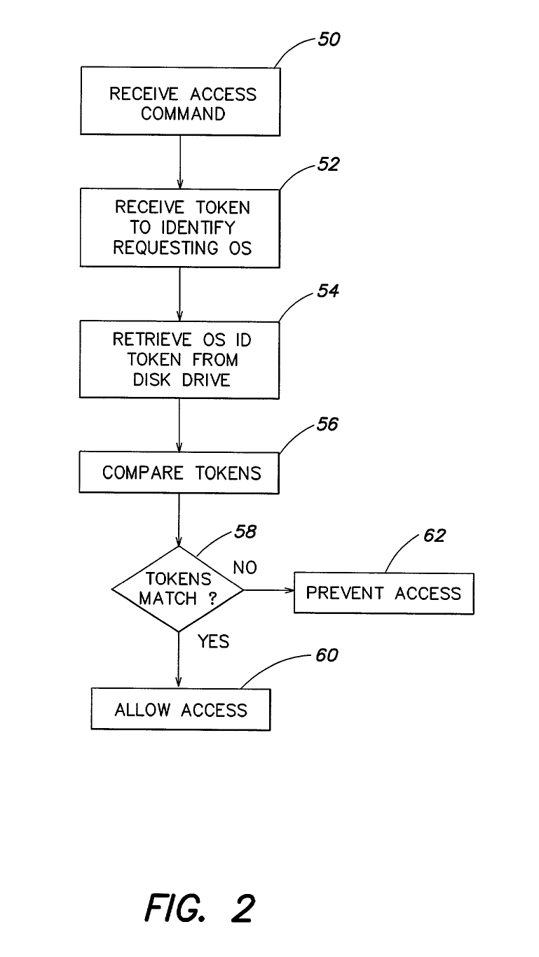

FIG. 2 is a flow chart that provides an overview of an exemplary process performed in accordance with the invention to control access to a disk drive so as to prevent or reduce the potential for corruption of user data by unplanned transfer of the disk drive from one operating system to another. The present invention may be implemented, for example, in a conventional computer system of the types described above in connection with FIGS. 1 or 1A or in any other suitable computer system. For the purposes of the ensuing description, it will be assumed that the process illustrated in FIG. 2 is controlled by the storage adapter 18 shown in FIG. 1. However, with few if any modifications the processes of the present invention can alternatively be controlled at the level of a storage subsystem (FIG. 1A), at the level of an individual storage device 26 or at the level of a device driver (e.g., via device driver software 22 or 24).

Referring, to FIG. 2, the process illustrated therein commences with block 50, at which the storage adapter 18 receives from the processing block 12 a command requesting access to a particular one of the storage devices 26. (As used in this description and in the appended claims, “accessing” a data storage device includes at least one of writing data to the storage device and reading data from the storage device.) In conjunction with, or following, block 50 is block 52, at which the storage adapter 18 receives from the processing block 12 (and in particular from the device driver software 22) data which identifies the operating system (OS) that initiated the access command received at block 50. The data which identifies the OS that initiated the access command may be received by the storage adapter 18 in a number of ways, e.g., included in a command from the processing block 12 or by the processing block 12 writing the data in a register (not separately shown) in the storage adapter 18. (Data which identifies an operating system will sometimes be referred to herein and in the appended claims as a “token”.)

In one embodiment of the invention, a token may be communicated to the storage adapter 18 independently of the access command (e.g., via a separate command or some other mechanism), and the storage adapter 18 may store the token. Thereafter, when the storage adapter 18 receives an access command, the token stored by the storage adapter 18 may be compared to a token retrieved from one of the storage devices 26 as described further below. In another embodiment, a token may be communicated to the storage adapter 18 as part of an access command (e.g., as an additional command parameter).

Following blocks 50 and 52 is block 54. At block 54, the storage adapter 18 retrieves from the data storage device 26 (referred to in the received access command received at block 50) a token which had previously been stored in the data storage device 26 to identify the operating system (OS) with which the data storage device 26 had been associated (e.g., an “OS ID token”). It will be understood that a data storage device 26 is “associated with” a particular operating system when part or all of the data storage device 26 has been assigned for use by the operating system. Exemplary techniques for associating data storage devices to operating systems (e.g., via operating system identification tokens) are described below.

Following block 54 is block 56. At block 56 the storage adapter 18 compares the tokens which were respectively received at block 52 and retrieved from the data storage device at block 54. Following block 56 is a decision block 58, at which it is determined whether the two tokens match. If a positive determination is made at decision block 58 (e.g., if the tokens match), then the operating system seeking to access the data storage device 26 in question is the same as the operating system to which the data storage device has been assigned. Consequently, block 60 follows, at which access to the data storage device 26 is allowed. However, if a negative determination is made at block 58 (e.g., if the tokens do not match), then the operating system seeking access to the data storage device 26 is not the operating system to which the data storage device 26 has been assigned. In that case, block 62 follows decision block 58. At block 62, access to the data storage device 26 is prevented.

While the foregoing discussion is sufficient to enable one of ordinary skill in the art to practice the invention, additional details and certain special situations will now be described to provide a more complete understanding of the invention.

In one embodiment, each token which identifies the operating system with which a storage device is associated may be stored in a reserved sector or sectors of the storage device. Each token may, for example, identify a type of operating system, such as AIX, OS/400, or Linux. A token need not distinguish between multiple instances of the same operating system type. That is, multiple instances of the same operating system type may share the same token.

Because one or more sectors of a given data storage device 26 are reserved for the operating system identifying data/token, the storage adapter 18 reports to the processing block 12 a storage capacity for the data storage device 26 that is slightly smaller than its actual capacity. The reduction in capacity is not significant, given that the data storage device 26 may have a total capacity of millions or tens of millions of sectors, whereas only one or a few sectors typically are reserved for storage of the operating system identifying data. From the point of view of the operating system, the data storage device 26 still provides a single contiguous range of logical block addresses. Consequently, there is no need to change operating system software, since the reserving of the sector or sectors for an operating system identifying token is transparent to the respective operating system. Thus the operating system can interact with a data storage device 26 that is assigned to it in the same manner as if the present invention were not implemented.

In at least one embodiment of the invention, initially, i.e. before a data storage device 26 is assigned to an operating system, the reserved sector or sectors of the data storage device may store a “default” token, i.e. a token which indicates no operating system identification. When the default token is stored in the data storage device 26, the first operating system which seeks to access the data storage device is allowed to do so. Thereafter, and preferably upon the operating system commanding a write operation, the token identifying the operating system is stored in the reserved sector or sectors of the data storage device. Alternatively, the token identifying the operating system may be written into the reserved sector or sectors of the data storage device upon any access, whether read or write, or upon assignment of the data storage device to the operating system. However, by deferring the writing of an operating system identification token to a data storage device until the first write command, it may be possible to eliminate the need for the recovery procedure described below if the data storage device is transferred to a second operating system prior to being written to by the first operating system.

To accommodate boot up procedures, prior to receiving an operating system identification token, the storage adapter 18 may allow read commands but prevent write commands. Thus the invention supports common boot drivers, which are drivers that are capable of loading multiple different operating systems. As is understood by those who are skilled in the art, such a common boot driver is not aware of which operating system is being loaded. At the time of booting, the boot driver, which may be stored, for example, in flash memory (not separately shown) on the processing block 12, loads a specific predetermined region of a data storage device 26 into system memory (not separately shown). The data loaded contains the initial boot image for the operating system to be loaded. After the data is loaded, the boot driver passes control to the code which was loaded in the system memory and that code begins executing to boot up the operating system. For example, computer systems of the IBM pSeries, which are available from the assignee of the present invention, have a common boot driver that loads either the AIX operating system or the Linux operating system.

In at least one embodiment of the invention, during a boot up by a common boot driver in a computer system in which the present invention is implemented, the common boot driver does not send an operating system identification token to the storage adapter 18. The storage adapter 18 reacts by allowing reads from the data storage device 26 in question, but preventing writes. The common boot driver issues read requests to load the operating system image into system memory. The common boot driver is unaware of which operating system is stored in the data storage device 26, and also is unaware of which operating system identification token, if any, is stored in reserved section or sections of the data storage device 26. The operating system image contains a device driver for the storage adapter 18. The device driver is specific to the particular type of operating system and to the storage adapter 18. When control is passed to the operating system image in system memory, the device driver from the operating system image is used. The device driver then sends to the storage adapter 18 the operating system identification token, which may then be compared against the token stored in the data storage device 26 to validate that the tokens match, to allow full operation with respect to both reads and writes. The system boot process can then be completed.

Following is an example of how the present invention operates in a case where a data storage device 26 is inadvertently transferred between operating systems.

### EXAMPLE A

1. A data storage device 26 is assigned to operating system A. The operating system identification token stored in the data storage device 26 corresponds to the type of operating system A. To permit reads and writes by operating system A, the corresponding device driver (e.g., device driver software 22 or 24) communicates the identification token of the operating system A to the storage adapter 18. Reads and writes are permitted because the token sent from the device driver to the storage adapter 18 matches the token stored in the data storage device 26.

2. The data storage device 26 is transferred (inadvertently) to operating system B. This may occur due to operator error.

3. Operating system B attempts to access the data storage device 26. The corresponding device driver for operating system B communicates to the storage adapter 18 the operating system identification token corresponding to operating system B. The storage adapter 18 prevents the operating system B from accessing the data storage device 26 because the token received from the device driver does not match the token stored in the data storage device 26. Writing of configuration data or the like by operating system B to the data storage device 26 is prevented, thereby preventing corruption of user data stored in the data storage device 26 by operating system A. The identification token corresponding to operating system B is not stored on the data storage device 26. An error message is issued to indicate, for example, that access to the data storage device 26 is refused and that a device format operation is required.

4. The data storage device 26 is transferred back to operating system A with all contents of the data storage device 26 unchanged.

5. Operating system A attempts to access the data storage device 26. The device driver for operating system A sends to the storage adapter 18 the identification token which corresponds to operating system A. The storage adapter 18 allows access to the data storage device 26, because the received token identifying operating system A matches the token stored on the data storage device 26.

It will be appreciated that the technique of the present invention has operated in this case to prevent corruption of the user data stored by operating system A on the data storage device 26 notwithstanding the inadvertent transfer of the data storage device 26 to operating system B.

Following is an example of operation of the present invention in a case where a data storage device 26 is intentionally transferred from one operating system to another.

### EXAMPLE B

The first three steps of this example are the same as the first three steps of Example A above, except that the transfer of the data storage device 26 to operating system B in step 2 is intentional rather than inadvertent.

4. In response to the error message in step 3, a user follows a system error recovery procedure to issue a format command for the data storage device 26. The data storage device 26 is formatted, and the “default” token is stored in the reserved sector or sectors of the data storage device 26 in place of the token which identifies operating system A.

5. Because the “default” token is now stored in the data storage device 26, operating system B can access the data storage device 26. The token identifying operating system B is written into the reserved sector or sectors of the data storage device 26 upon the first write operation carried out by operating system B with respect to the data storage device 26.

With this example it is seen how a system user is required to take special steps such as an error recovery procedure in order to assure that a transfer of a data storage device 26 from one operating system to another is intentional and not inadvertent.

In the foregoing examples, a format command was used as an error recovery process to confirm that a transfer of a data storage device 26 from one operating system to another was intentional. This is advantageous because such a format command is likely to be available in conventional operating systems. However, it is also contemplated to use a special command, which might be denominated as a “recovery” or “token change” command, and may be implemented in the respective device drivers for each operating system pertinent to the storage adapter 18, to carry out the function of changing the operating system identification token stored in the data storage device 26. For example, using a “token change” command could permit migration of a data storage device 26 from one operating system to another while preserving the data contents of the data storage device 26, in a case where the respective operating systems are familiar with each other's file system layouts.

Although one embodiment of the invention prohibits both writes and reads to the data storage device 26 when the operating system identification token passed to the storage adapter 18 from the processing block 12 fails to match the operating system identification token stored in the data storage device 26, it is also contemplated to prohibit only write operations. However, preventing read operations as well may be preferable in that it tends to force performance of the recovery procedure upon the first read when an intentional transfer of the data storage device 26 from one operating system to another is to be carried out.

The foregoing description discloses only exemplary embodiments of the invention; modifications of the above disclosed apparatus and methods which fall within the scope of the invention will be readily apparent to those of ordinary skill in the art. For example, the above description has assumed that each storage device 26 is dedicated for use by a single operating system at any given time. However, it is also contemplated to apply the present invention to situations in which a data storage device 26 is partitioned/shared between two or more operating systems. In such a case, two or more operating system identification tokens may be stored in the data storage device 26. Alternatively, two or more operating systems may share a common token. In at least one embodiment of the invention, the result of a comparison between (1) a token which identifies an operating system that initiated an access command (block 52 in FIG. 2), and (2) a token stored in a data storage device 26 that identifies the operating system with which the data storage device 26 has been associated (block 54 in FIG. 2), may be stored by the storage adapter 18. In this manner, when an access command is received by the storage adapter 18, the result of the respective token comparison is already available and an immediate determination can be made regarding whether or not the access command should be allowed to access the storage device 26.

Accordingly, while the present invention has been disclosed in connection with exemplary embodiments thereof, it should be understood that other embodiments may fall within the spirit and scope of the invention, as defined by the following claims.

The invention claimed is:

1. A method of operating a data storage device, comprising:
associating the data storage device with a first operating system; and
storing in the data storage device data that identifies the first operating system.

2. The method of claim 1, wherein the storing step is performed in response to the associating step.

3. The method of claim 1, further comprising:
preventing a second operating system from accessing the data storage device.

4. The method of claim 3, wherein the preventing step includes referring to the stored data that identifies the first operating system.

5. The method of claim 3, wherein the preventing step is performed by a storage adapter connected to the data storage device.

6. The method of claim 5, wherein the storage adapter operates to:
retrieve from the data storage device the data that identifies the first operating system;
receive from device driver software adapted to manage the storage adapter data that identifies the second operating system; and
compare the retrieved data with the received data.

7. The method of claim 3, wherein the preventing step is performed by a storage subsystem that includes the data storage device.

8. The method of claim 1, wherein the data storage device is a disk drive.

9. A method of operating a data storage device, comprising:
receiving an access command that requests access to the data storage device;
receiving a first token that identifies an operating system that issued the access command;
retrieving from the data storage device a second token that identifies an operating system with which the data storage device is associated;
comparing the first and second tokens;
allowing access to the data storage device if the first and second tokens match; and
preventing access to the data storage device if the first and second tokens do not match.

10. The method of claim 9, wherein the access command is a write command.

11. The method of claim 9, wherein the data storage device is a disk drive.

12. The method of claim 11, wherein the second token is stored in at least one reserved sector of the disk drive.

13. A computer system, comprising:
a processing block, including one or more processors, the processing block being operable with a plurality of operating systems including at least a first operating system and a second operating system;
a storage adapter connected to the processing block;
a data storage device connected to the storage adapter;
means for associating the data storage device with the first operating system; and
means for storing in the data storage device data that identifies the first operating system.

14. The computer system of claim 13, wherein the means for storing is responsive to the means for associating.

15. The computer system of claim 13, further comprising means for preventing the second operating system from accessing the data storage device.

16. The computer system of claim 15, wherein the means for preventing includes means for referring to the stored data that identifies the first operating system.

17. The computer system of claim 15, wherein the storage adapter includes the means for preventing.

18. The computer system of claim 17, wherein the storage adapter operates to:
retrieve from the data storage device the data that identifies the first operating system;
receive from device driver software adapted to manage the storage adapter data that identifies the second operating system; and
compare the retrieved data with the received data.

19. The computer system of claim 13, wherein the storage adapter and the data storage device are part of a storage subsystem that is connected to the processing block.

20. The computer system of claim 19, wherein the storage subsystem includes means for preventing the second operating system from accessing the data storage device.

21. The computer system of claim 13, wherein the data storage device is a disk drive.

22. A computer system, comprising:
a processing block, including one or more processors;
a storage adapter connected to the processing block; and
a data storage device connected to the storage adapter;
wherein the storage adapter is adapted to:
receive from the processing block an access command that requests access to the data storage device;
receive from the processing block a first token that identifies an operating system that issued the access command;
retrieve from the data storage device a second token that identifies an operating system with which the data storage device is associated;
compare the first and second tokens;
allow access to the data storage device if the first and second tokens match; and
prevent access to the data storage device if the first and second tokens do not match.

23. The computer system of claim 22, wherein the access command is a write command.

24. The computer system of claim 22, wherein the data storage device is a disk drive.

25. The computer system of claim 24, wherein the second token is stored in at least one reserved sector of the disk drive.

26. A computer system, comprising:
a processing block, including one or more processors; and
a storage subsystem that includes a data storage device;
wherein the storage subsystem is adapted to:
receive from the processing block an access command that requests access to the data storage device;
receive from the processing block a first token that identifies an operating system that issued the access command;
retrieve from the data storage device a second token that identifies an operating system with which the data storage device is associated;
compare the first and second tokens;
allow access to the data storage device if the first and second tokens match; and
prevent access to the data storage device if the first and second tokens do not match.

27. A computer program product for operating a data storage device, comprising:
a medium readable by a computer, the computer readable medium having computer program code adapted to:
associate the data storage device with a first operating system; and
store in the data storage device data that identifies the first operating system.

28. A computer program product for operating a data storage device, comprising:
a medium readable by a computer, the computer readable medium having computer program code adapted to:
receive an access command that requests access to the data storage device;
receive a first token that identifies an operating system that issued the access command;
retrieve from the storage device a second token that identifies an operating system with which the data storage device is associated;
compare the first and second tokens;
allow access to the data storage device if the first and second tokens match; and
prevent access to the data storage device if the first and second tokens do not match.
